(19) United States
(12) Patent Application Publication
(10) Pub. No.: US 2003/0158351 A1
(43) Pub. Date: Aug. 21, 2003

(54) Phenylethynyl-containing imide silanes

(76) Inventors: Joseph G. Smith JR., Smithfield, VA (US); John W. Connell, Yorktown, VA (US); Paul M. Hergenrother, Yorktown, VA (US); Sharon E. Lowther, Hampton, VA (US); Cheol Park, Yorktown, VA (US)

Correspondence Address: NATIONAL AERONAUTICS AND SPACE ADMINISTR, ATION LANGLEY RESEARCH CENTER, 3 LANGLEY BOULEVARD, MAIL STOP 212, HAMPTON, VA, 236812199

(21) Appl. No.: 10/167,710

(22) Filed: Jun. 12, 2002

Related U.S. Application Data
(63) Continuation-in-part of application No. 09/783,578, filed on Feb. 9, 2001, now abandoned.
(60) Provisional application No. 60/181,434, filed on Feb. 10, 2000.

(51) Int. Cl. C08L 77/00; C08L 83/00; C07F 7/02

(52) U.S. Cl. 525/431; 548/110

(57) ABSTRACT

Phenylethynyl containing imide-silanes were prepared from aminoalkyl and aminoaryl alkoxy silanes and 4-phenyletbynylphthalic anhydride in toluene to form the imide in one step or in N-methyl-2-pyrrolidinone (NMP) to form the amide acid intermediate. Controlled molecular weight pendent phenylethynyl amide acid oligomers terminated with aminoaryl alkoxy silanes were prepared in NMP from aromatic dianhydrides, aromatic diamines, diamines containing pendent phenylethynyl groups and aminoaryl alkoxy silanes. The phenylethynyl containing imide-silanes and controlled molecular weight pendent phenylethynyl amide acid oligomers terminated with aminoaryl alkoxy silanes were used to improve the adhesion between phenylethynyl containing imide adhesives and inorganic substrates (i.e. metal). Hydrolysis of the alkoxy silane moiety formed a silanol functionality which reacted with the metal surface to form a metal-oxygen-silicon (oxane) bond under the appropriate reaction conditions. Upon thermal cure, the phenylethynyl group of the coupling agent reacts with the phenylethynyl functionality of phenylethynyl containing imide adhesives and becomes chemically bonded to the matrix. The resultant adhesive bond is more durable (i.e. hot-wet environmental resistance) than adhesive bonds made without the use of the coupling agent due to covalent bond formation between the phenylethynyl containing imide-silane coupling agent or the controlled molecular weight pendent phenylethynyl amide acid oligomers terminated with aminoaryl alkoxy silanes and both the metal substrate and phenylethynyl containing imide adhesives.

### CROSS-REFERENCE TO RELATED APPLICATIONS

This application is a continuation-in-part application of pending U.S. patent application Ser. No. 09/783,578, filed Feb. 9, 2001, now abandoned, which in turn claims benefit of priority from U.S. provisional application No. 60/181,434, with a filing date of Feb. 10, 2000.

### ORIGIN OF INVENTION

The invention described herein was jointly made by an employee of the National Research Council and employees of the U.S. Government and may be manufactured and used by or for the Government for governmental purposes without payment of any royalties thereon or therefor.

### FIELD OF THE INVENTION

This invention relates generally to phenylethynyl-containing imide silanes, and more particularly to methods for making phenylethynyl-containing imide silanes.

### BACKGROUND OF INVENTION

The literature (i.e. Silanes and Other Coupling Agents, Ed. K. L. Mittal, VSP BV, 1992) and practical experience teaches that the adhesive strength of a high temperature organic resin to an inorganic substrate (i.e. glass, metal, or ceramic) is severely diminished after exposure to a hot-wet environment as compared to dry unexposed samples. This is primarily due to water attacking the interface between the high temperature organic resin and inorganic substrate. To improve the adhesion and the durability between the inorganic substrate and high temperature organic resin especially under hot-wet conditions, coupling agents have been employed. By definition, coupling agents improve the chemical resistance and the hot-wet performance of the interface between organic and inorganic substrates. In general, most coupling agents are silicon based and contain two types of functionalities: one organic and the other inorganic. The generic structure is:

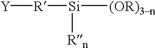

where R is typically an alkyl moiety such as methyl, ethyl, or acetyl, R′ is an alkylene or arylene moiety, R″ is an alkyl or aryl group, Y is a functional group such as amino, epoxy, chloro, or vinyl, and n is 0, 1, or 2.

The inorganic functionality, alkoxy silane [—Si(OR)₃₋ₙ], hydrolyzes under the appropriate acidic or basic conditions to form the corresponding silanol groups [—Si(OH)₃₋ₙ] which subsequently react with hydroxyl groups present on the inorganic substrate (i.e. glass, metal, etc.) surface by a condensation process to form an oxane bond (—Si—O-inorganic substrate) with the simultaneous loss of water. At the same time, the silanol groups on one molecule can react with another silanol functionality of another molecule to form a 3-dimensional network consisting of siloxane linkages with the simultaneous loss of water. The formation of the oxane bond makes the substrate surface less polar. As a consequence the diffusion of water to the surface is severely curtailed and the retention of adhesive strength under hot-wet conditions is improved. Increased hydrophobic character and resistance to attack of water at the interface can be achieved by the proper choice of the alkylene or arylene (R′) group of the coupling agent [G. Tesoro and Y. Lu, J. Adhesion Sci. Technol., 5 (10), 771-784 (1991); P. Walker, J. Adhesion Sci. Technol., 5 (4), 279-305 (1991)].

The number of hydrolyzable groups present in the coupling agent will influence the interface characteristics. Typical silane coupling agents have 3 hydrolyzable groups (i.e. alkoxy) which afford the maximum hydrolytic stability, but are usually hygroscopic. Silane coupling agents containing two hydrolyzable groups afford less rigid interfaces than those containing three hydrolyzable groups. Those containing only one hydrolyzable group afford the most hydrophobic interface; however, they usually exhibit the lowest long term hydrolytic stability.

The bond formation of the organic functionality of the coupling agent-inorganic substrate interface to the organic resin differs for thermosetting and thermoplastic polymers. For thermosetting polymers, the organic residue of the coupling agent reacts with the appropriate functionalities in the resin. Examples include aminosilanes with epoxy or phenolic resins and vinylsilanes with unsaturated polyesters [P. G. Pape, “Silane Coupling Agents (Adhesion Promoters)” in Polymeric Materials Encyclopedia, CRC Press, Inc., 7636-7639, (1996)]. Bond formation between a thermoplastic polymer and coupling agent has been described as an interpenetrating network formation. In this case, the resin penetrates the coupling agent-inorganic substrate interface to provide bonds through physical and electrostatic effects [P. G. Pape, “Silane Coupling Agents (Adhesion Promoters)” in Polymeric Materials Encyclopedia, CRC Press, Inc., 7636-7639, (1996); W. D. Bascom, “Primers and Coupling Agents”, in Engineered Materials Handbook, Vol. 3, Adhesives and Sealants, ASM International, 254-258 (1990)]. Examples include polyimides terminated with γ-aminopropyltriethoxysilane [C. K. Ober and N. A. Johnen, Polym. Prep., 36 (1), 715-716 (1995); S. A. Srinivasan, J. L. Hedrick, R. D. Miller, and R. Di Pietro, Polymer, 38 (12), 3129-3133 (1997); K. R. Carter, S. A. Srinivasan, J. L. Hedrick, R. D. Miller, V. Y. Lee, R. A. Di Pietro, and T. Nguyen, “Chain Extendable Polyimides from Trialkoxysilyl Functionalized Poly(amic Ester) Oligomers” in Polyimides and Other Low Dielectrics, Sixth International Conference Proceedings, H. S. Sachedev ed., Society of Plastic Engineers, 1998, in press] and imide compounds containing silanes [D. Lohmann, S. Wyler, U.S. Pat. No. 4,271,074 ( Jun. 2, 1981) to Ciba-Geigy; G. C. Tesoro, D. R. Uhlmann, G. P. Rajendran, and C. E. Park, U.S. Pat. No. 4,778,727 (Oct. 18, 1988) to Massachusetts Institute of Technology; G. C. Tesoro, G. P. Rajendran, C. E. Park, and D. R. Uhlmann, J. Adhesion Sci. Technol., 1, 39-51 (1987)].

Application of a silane coupling agent to the inorganic substrate (i.e. glass, metal, ceramic, etc.) is typically performed from a dilute, prehydrolyzed solution by spraying, dipping, direct mixing, or in the form of a primer. One example of this general methodology is set forth in U.S. Pat. No. 6,084,106 (Crook et al.), which describes the use of certain phenylethynyl terminated silanes as adhesion promoters on titanium lap shear panels.

This present invention constitutes a new composition of matter. It concerns novel phenylethynyl containing imide-silanes and controlled molecular weight pendent phenylethynyl amide acid oligomers terminated with alkoxy silanes and their use as coupling agents with any phenylethynyl containing polymer, co-polymer, oligomer, or co-oligomer and any inorganic substrate (i.e. glass, metal, ceramic, etc.) to improve durability, especially under hot-wet conditions, of bonded parts using phenylethynyl containing adhesives.

Another object of the present invention is the use of novel phenylethynyl containing imide-silanes and controlled molecular weight pendent phenylethynyl amide acid oligomers terminated with alkoxy silanes as sizing agents on fibers (glass, carbon, organic, etc.) to improve the durability, especially under hot-wet conditions, of composites fabricated from any phenylethynyl containing polymer, co-polymer, oligomer, co-oligomer, or monomer.

Another object of the present invention is the use of novel phenylethynyl containing imide-silanes and controlled molecular weight pendent phenylethynyl amide acid oligomers terminated with alkoxy silanes as protective coatings (i.e. corrosion, wear-resistance, etc.) on substrates (glass, carbon, organic, etc.) to protect the underlying surface from harsh environments.

Another object of the present invention is the composition of new resins derived from phenylethynyl containing imide-silanes and any phenylethynyl containing polymer, co-polymer, oligomer, co-oligomer, or monomer.

These and other objects are achieved by the present invention, as hereinafter described.

### SUMMARY OF THE INVENTION

In one aspect, the present invention relates to novel compositions of matter, and to methods of making and using the same, which compositions have the structure

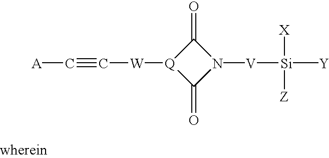

A is an aryl group,

W is an arylene linking group or a covalent bond,

Q is an aryl radical,

V is an alkylene or arylene radical,

Z is an alkyl or aryl group, and

X and Y are independently selected from the group consisting of OH, OR¹ and R², where R¹ and R² are each independently alkyl or aryl groups.

In various specific embodiments of this aspect of the invention, A is a phenyl or naphthyl group; W is a covalent bond or an arylene linking group such as a phenoxy or phenyl radical; Q is a benzene radical or a naphthalene radical; V is an alkylene linkage containing 1 to 8 carbon atoms, such as a methylene linkage, an ethylene linkage, or a propylene linkage, or else V is a benzene or naphthalene radical; and X and Y are alkoxy groups, such as methoxy or ethoxy groups, or are hydroxy groups. Preferably, these various parameters are chosen such that A is conjugated with Q and/or with one or both of the carbonyl groups in the imide ring, as such hyperconjugation gives rise to useful properties such as fluorescence which allow the material to be readily detected on a surface to which it is applied. In a particularly preferred embodiment of this aspect of the invention, the novel compositions have the structure

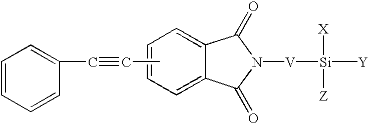

wherein V, X, Y and Z are defined as above.

The novel compositions of this aspect of the invention may be used alone or in conjunction with a phenylethynyl containing amide acid, such as an amide acid having the structure

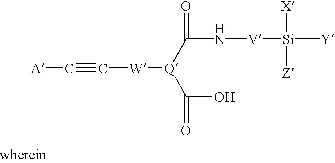

A′ is an aryl moiety,

W′ is an arylene linking group or a covalent bond,

Q′ is an aryl radical,

V′ is an alkylene or arylene linking group, and

X′, Y′ and Z′ are selected from the group consisting of OH, OR³ and R⁴, where R³ and R⁴ are each independently an alkyl or aryl moiety. In various specific embodiments of this aspect of the invention which include the above noted amide acid, A′ is a phenyl group; W′ is a covalent bond; Q′ is a benzene radical; and X′, Y′ and Z′ are alkoxy groups. One particularly preferred amide acid has the structure

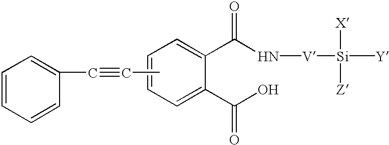

where V′, X′, Y′ and Z′ are as noted above.

In another aspect, the present invention relates to novel compositions of matter, and to methods of making and using the same, which compositions have the structure

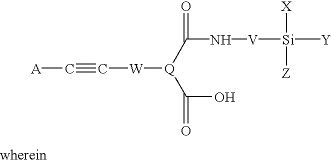

A is an aryl group,

W is an arylene linking group or a convalent bond,

Q is an aryl radical,

V is an alkylene or arylene radical, and

X, Y and Z are independently selected from the group consisting of OH, OR¹ and R², where R¹ and R² are each independently alkyl or aryl groups.

In various specific embodiments of the aspect of the invention, A is a phenyl or naphthyl group; W is a covalent bond or an arylene linking group; Q is a benzene radical or a naphthalene radical; V is an alkylene linkage containing 1 to 8 carbon atoms, such as a methylene linkage, an ethylene linkage or a propylene linkage, or else V is a benzene or naphthalene radical; X, Y and Z are alkoxy groups, such as methoxy or ethoxy groups, or are hydroxy groups. Preferably, these various parameters are chosen such that A is conjugated with Q and/or with one or both of the carbonyl groups in the acid amide. Preferably, the acid amides of this aspect of the invention have the structure

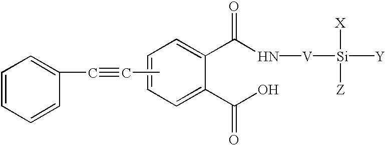

wherein V, X, Y and Z are defined as above.

In yet another aspect, the present invention relates to compositions of matter, and to methods of making and using the same, which compositions have a component with the structure

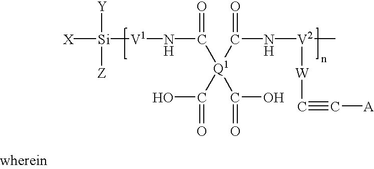

V¹ is an alkylene or arylene linking group;

n approximately ranges from 1 to 1,000;

V² is an arylene linking group;

W is an arylene linking group or a covalent bond;

Q¹ and A are aryl radicals;

X, Y and Z are independently selected from the group consisting of R¹, OR² and OH, and wherein R¹ is an alkyl or aryl group. Preferably, the compositions of matter of this aspect of the invention, which may be oligomers, polymers, or copolymers, have the structure

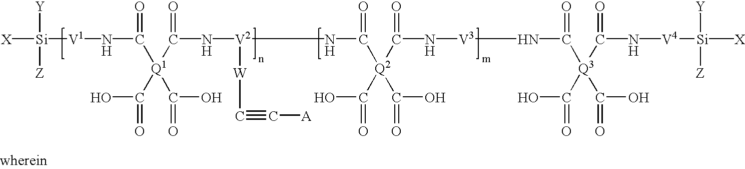

A is a naphthyl or phenyl group,

n approximately ranges from 1 to 1,000, and m approximately ranges is from 1 to 1,000,

W is an arylene linking group or a covalent bond,

Q¹, Q² and Q³ are aryl radicals,

V¹ and V⁴ are alkylene or arylene linking groups,

V² and V³ are arylene linking groups, and

X, Y and Z are independently selected from the group consisting of R¹, OH and OR², where R¹ and R² are independently alkyl or aryl moieties.

In various specific embodiments of this aspect of the invention, W is a covalent bond and A is a phenyl group; V² and V³ are aromatic diamines; X, Y and Z are each alkoxy groups (e.g., methoxy or ethoxy) or hydroxy groups; A is a phenyl radical or a naphthyl radical; W is a covalent bond or an arylene linking group; Q¹ is a benzene radical, a naphthyl radical, or a biphenyl radical; and V¹ is an alkylene linkage containing 1 to 8 carbon atoms, such as a methylene, ethylene or propylene group. Preferably, these various parameters are selected such that A is conjugated with one or more of the carbonyl groups attached to Q¹.

In still another aspect, the present invention relates to compositions of matter, and to methods of making and using the same, which compositions have a component with the structure

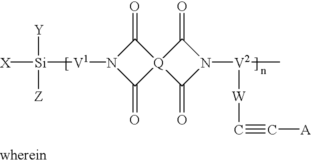

A is an aromatic or aryl group,

n approximately ranges from 1 to 1,000,

W is an arylene linking group or a covalent bond,

Q is an aryl radical,

V¹ and V² are alkylene or arylene radicals, and

X, Y and Z are independently selected from the group consisting of OH, OR¹ and R², where R¹ and R² are each independently alkyl or aryl groups.

In various specific embodiments of this aspect of the invention, A is a phenyl or naphthyl group; W is a covalent bond or an alkylene linking group; Q is a benzene radical or a naphthalene radical; V¹ is an alkylene linkage containing 1 to 8 carbon atoms, such as a methylene linkage, an ethylene linkage, or a propylene linkage, or else V¹ is a benzene or naphthalene radical; X, Y and Z are alkoxy groups, such as methoxy or ethoxy groups, or are hydroxy groups. Preferably, these various parameters are chosen such that A is conjugated with Q and/or with one or both of the carbonyl groups in the acid amide.

The various novel compositions noted in the above aspects of the present invention may be further reacted with monomers, oligomers, polymers, or copolymers, especially those containing one or more phenylethynyl groups, to yield further novel compositions. Moreover, various combinations and subcombinations of the various novel compositions noted in the above aspects of the present invention may be used together.

The various above noted novel compositions of the present invention are particularly useful for treating inorganic substrates comprising titanium. In such treatments, they may be combined with a tetraalkoxysilane such as tetraethoxysilane, and/or with a phenylethylamide acid, including (but not limited to) those specifically noted above. The novel compositions of the invention also find other uses, such as treatments or sizing agents for fibrous substrates, for use as composite materials (either with or without a reinforcing agent such as fiber), or for use as functionalizing agents for clays, nanotubes, and similar materials having hydroxy groups that are capable of undergoing a condensation reaction.

In still another aspect, the present invention relates to a method for forming imide silanes containing at least one phenylethynyl moiety. In accordance with the method, an anhydride containing at least one phenylethynyl moiety is reacted with a substituted silane containing a primary amine group, thereby generating an imide and water. The water is removed essentially simultaneously with the formation of the imide by, for example, reacting the anhydride and the silane in a solvent medium such as toluene which is capable of forming an azeotrope with water.

According to the present invention the foregoing and additional objects were obtained by synthesizing the amide acid and imide forms of phenylethynyl containing imide-silane coupling agents (APEIS) from primary amine containing substituted silanes and phenylethynyl containing anhydrides. The general reaction sequence for the synthesis of the amide acid and imide forms of APEIS coupling agents are represented in Eqns. 1 and 2, respectively. As depicted in Eqn. 1, APEAAS has the potential to ring close in solution to form APEIS and water. The water generated from this imidization process can result in the premature cleavage of the alkoxy groups generating the silanol derivative since it would not be removed from solution. This was not the case in Eqn. 2 where the imide is formed directly with the simultaneous removal of water as an azeotrope with the solvent.

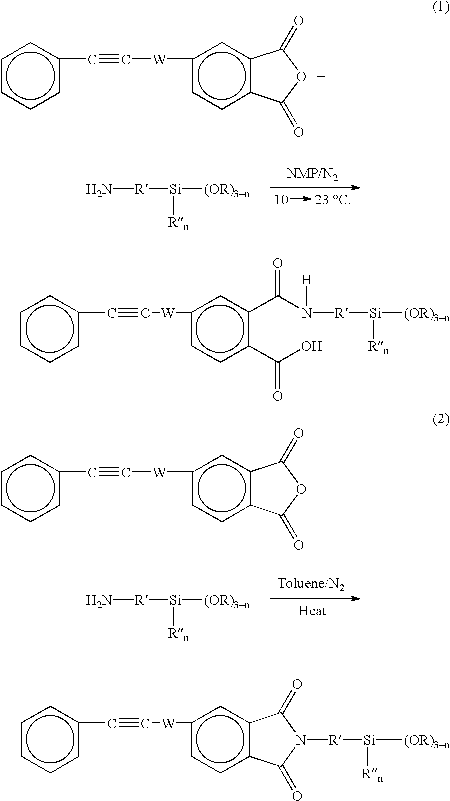

APEAAS and APEIS were dissolved in N-methyl-2-pyrrolidinone and hydrolyzed to the corresponding silanol derivative by the addition of water as represented in Eqns. 3 and 4, respectively.

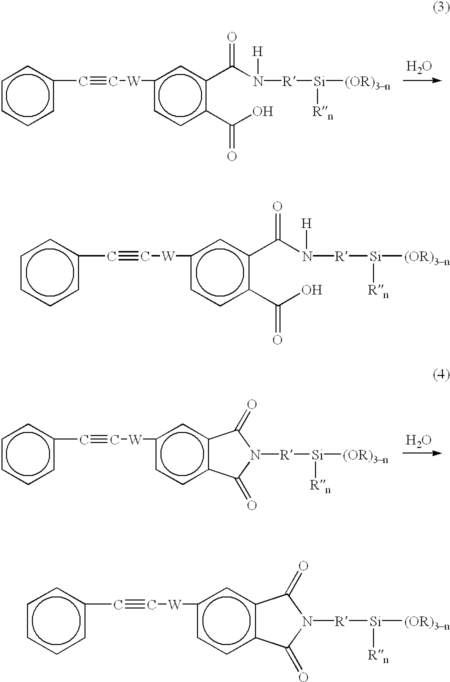

To demonstrate the concept of improved adhesion, the coupling agents were used on titanium (Ti) adherends bonded with a phenylethynyl-containing adhesive. Surface treatment of the Ti alloy (i.e. inorganic substrate) based upon hydrogen peroxide or sulfuric acid-sodium perborate were used. Sulfuric acid was employed to produce a fresh surface, while the alkaline perborate solution acted as an oxidizing agent to afford a new stable oxide layer. In the first case, the hydrolyzed forms of APEIS were applied to the surface treated inorganic substrate neat, as a mixture with tetraethoxysilane (TEOS), or as a mixture with TEOS and a phenylethynyl containing amide acid (PETI-5) by dip coating. Heat was then applied and the hydroxyl groups of the inorganic substrate condensed with the hydroxyl groups of the silanol derivative of APEIS or the silanol derivatives of APEIS and TEOS.

The coupling agent was also prepared as an oligomeric amide acid. Controlled molecular weight pendent phenylethynyl amide acid oligomers terminated with substituted silanes (PPEIDS) were prepared by the reaction of diamine(s) and diamine(s) containing pendent phenylethynyl group(s) with an excess of dianhydride(s) and endcapped with amine containing substituted silanes. The general reaction sequence for the synthesis of PPEIDS is represented in Eqn. 5. As described above for APEAAS, the amide acid can potentially ring close to the imide in solution thus generating water. This water by-product then has the potential to hydrolyze the alkoxy silane to the corresponding silanol derivative.

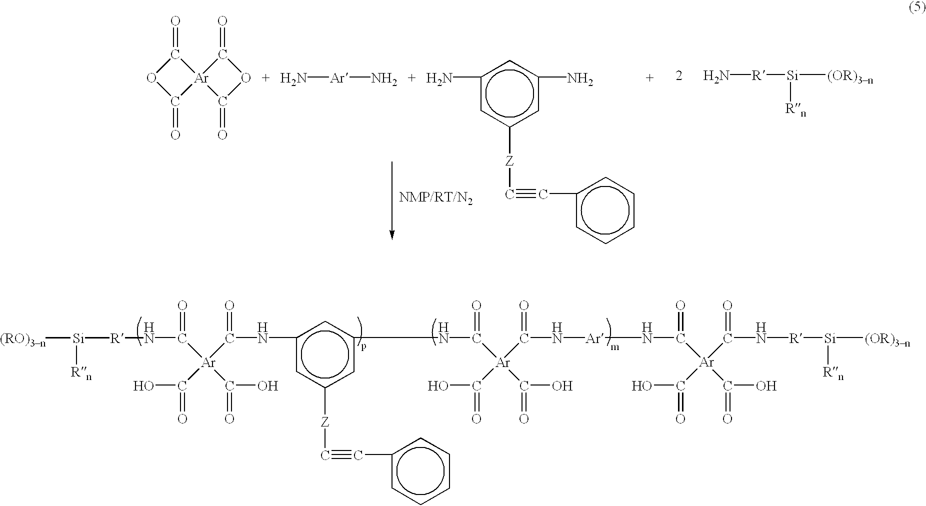

(where p approximately ranges from 1 to 1,000, and m approximately ranges from 1 to 1,000) To hydrolyze the substituted silanes to the corresponding silanols of the amide acid of PPEIDS, water was added to N-methyl-2-pyrrolidinone solutions of PPEIDS as represented in Eqn. 6. This silanol derivative of the amide acid of PPEIDS was then applied to the inorganic substrate (Ti alloy) neat or as a mixture with TEOS by a dip coating process. Subsequent heating resulted in oxane bond formation from the condensation of the silanol groups of the amide acid of PPEIDS with the hydroxyl groups present on the inorganic substrate as well as simultaneous cyclodehydration of the amide acid to the imide or from the condensation of the silanol groups of TEOS and the amide acid of PPEIDS with the hydroxyl groups present on the inorganic substrate as well as simultaneous cyclodehydration of the amide acid to the imide.

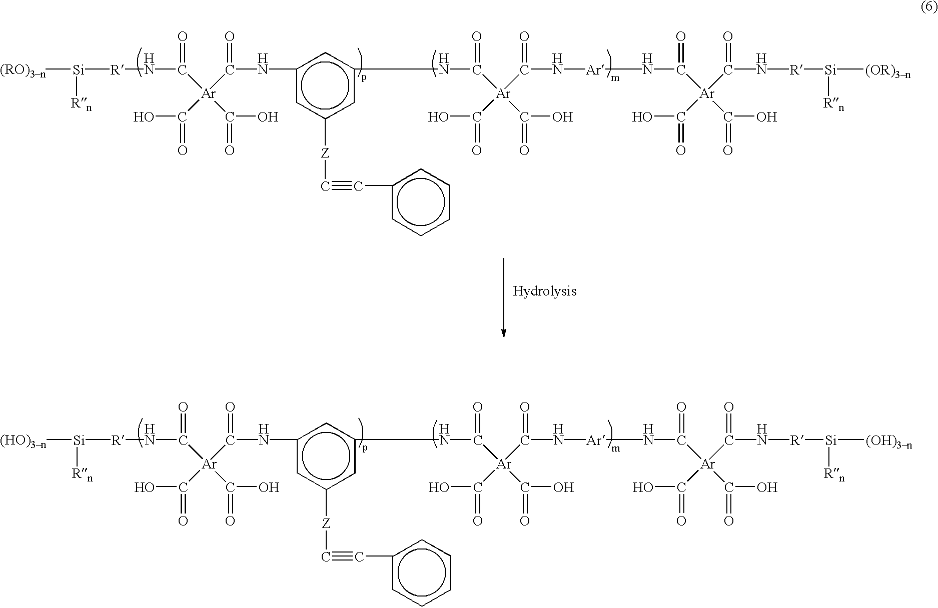

(where p approximately ranges from 1 to 1,000, and m approximately ranges from 1 to 1,000)

The effect on adhesive properties (lap shear strengths as determined according to ASTM D1002 using four specimens per test condition) were dependent on the surface treatment, the addition of TEOS, the addition of TEOS and a phenylethynyl containing amide acid (PETI-5), the form of the APEIS coupling agent (imide vs. amide acid), and PPEIDS with the results presented in Tables 1 and 3. TEOS has a higher driving force to diffuse towards the inorganic substrate presumably due to lower molecular weight and higher surface energy which allows it to deposit more readily on the inorganic oxide layer. The surface that is formed on the inorganic substrate is more rigid and hydrophobic than the untreated one. Upon thermal cure, the silanol derivative of the APEIS coupling agents (imide or amide acid) or the silanol derivative of the amide acid of PPEIDS can react with the surface of the inorganic substrate and phenylethynyl containing imide oligomers (e.g. PETI-5) to provide an interface between the inorganic and organic parts. The silanol groups react with the inorganic surface to form oxane and siloxane bonds and the phenylethynyl groups of the coupling agents (APEIS and PPEIDS) react with the phenylethynyl groups of the organic material through crosslinking and chain extension at elevated temperature. The APEIS and PPEIDS coupling agents improved the strength and durability of the adhesive bond between the inorganic substrate and phenylethynyl containing resins after exposure to hot-wet conditions as compared to similar specimens not containing these coupling agents.

### BRIEF DESCRIPTION OF THE FIGURES

FIG. 1 is a schematic illustration of the attachment of a blend of aromatic phenylethynyl containing imide-silanes (APEIS) and tetraethoxysilane to an inorganic substrate;

FIG. 2 is a schematic illustration of the attachment of pendant phenylethynyl disilanes to an inorganic substrate;

FIG. 3 is a graph of lap shear strength as a function of concentration of PPEIDS/TEOS;

FIG. 4 is an EDX line map of a cross-section of Ti-6-4/hybrid II (PPEIDS/TEOS);

FIG. 5 is a series of x-ray maps of a cross-section of Ti-6-4 hybrid II (PPEIDS TEOS);

FIG. 6a is a graph of elastic modulus as a function of TEOS composition in PPEIDS/TEOS;

FIG. 6b is a graph of tensile properties as a function of temperature; and

FIG. 7 is a graph of dynamic mechanical performance as a function of temperature for various compositions.

### DESCRIPTION OF THE PREFERRED EMBODIMENTS

In FIG. 1, the trialkoxy derivative of the aromatic phenylethynyl containing imide-silane (APEIS) is hydrolyzed under the appropriate reaction conditions to generate the hydroxy derivative. In some cases TEOS was used and upon hydrolysis under appropriate reaction conditions affords tetrahydroxysilane. The second step involves the application of the hydroxy derivative of APEIS and tetrahydroxysilane to an inorganic surface (i.e. metal, etc.), which had undergone an appropriate surface treatment to form surface hydroxyl groups. Condensation of the hydroxyl groups of tetrahydroxysilane with the hydroxyl groups on the inorganic surface results in an oxane interface. Upon this interface, the hydroxy derivative of APEIS reacts with the surface hydroxyl functionalities to form a covalent bond between APEIS and the inorganic substrate. Both bond forming reactions of tetrahydroxysilane and the hydroxy derivative of APEIS occur with the application of heat with the simultaneous loss of water. As depicted in FIG. 1, when a trihydroxy containing silane compound is used, one, two, or three siloxane bonds can form between the inorganic surface and APEIS. The probability of three siloxane bonds (Si—O—Si) to the surface is low due to the simultaneous formation of siloxane bonds between two adjacent APEISs. When TEOS is not employed, the hydroxy derivative of APEIS bonds directly to the interface forming oxane bonds (inorganic substrate-O—Si—).

FIG. 2 illustrates the bond formation between the inorganic substrate and the pendent phenylethynyl imide disilane (PPEIDS). Like APEIS, the amide acid of PPEIDS is initially hydrolyzed under the appropriate reaction conditions to generate the hydroxy derivative of the arylalkoxysilane end group. The hydroxysilane terminated amide acid of PPEIDS is subsequently applied to the inorganic surface (i.e. metal, etc.), which had undergone an appropriate surface treatment to form surface hydroxyl groups. Upon heating, condensation of the hydroxyl groups of the inorganic substrate and the hydroxysilane terminated amide acid of PPEIDS affords oxane bonds between the inorganic substrate and PPEIDS. Concurrently, water is lost from the ring closure of the amide acid to the imide. As previously described, when a trihydroxy silane end group is used, one, two, or three siloxane bonds can form between the surface and PPEIDS. However, the probability of three siloxane bonds (Si—O—Si) to the surface is low. This is due to the simultaneous formation of siloxane bonds between two adjacent PPEIDSs.

Aromatic Phenylethynyl Imide Silanes

APEIS were prepared from phenylethynylphthalic anhydrides and aminoalkoxylsilanes in the amide acid and imide forms. For example, the amide acid of APEIS (APEAAS-1) was prepared from 4-phenylethynylphthalic anhydride (PEPA) and aminophenyltrimethoxysilane (APTS) in N-methyl-2-pyrrolidinone (NMP) as depicted in Eqn. 1.

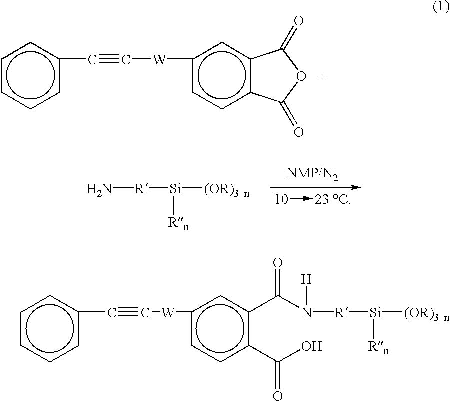

The imide form of APEAAS-1 designated APEIS-1 was prepared in refluxing toluene from PEPA and APTS as depicted in Eqn. 2.

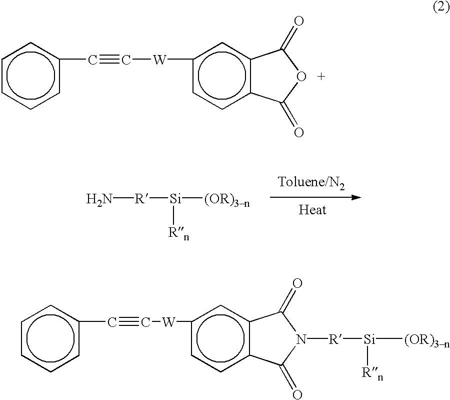

A second APEIS was prepared from γ-aminopropyltriethoxysilane and PEPA in refluxing toluene (APEIS-2). Both the amide acid and imide forms of APEISs were soluble in NMP at room temperature. Hydrolysis of the alkoxysilane functionality to generate a silanol functionality was accomplished by the addition of water to NMP solutions of APEAAS and APEIS as depicted in Eqns. 3 and 4, respectively.

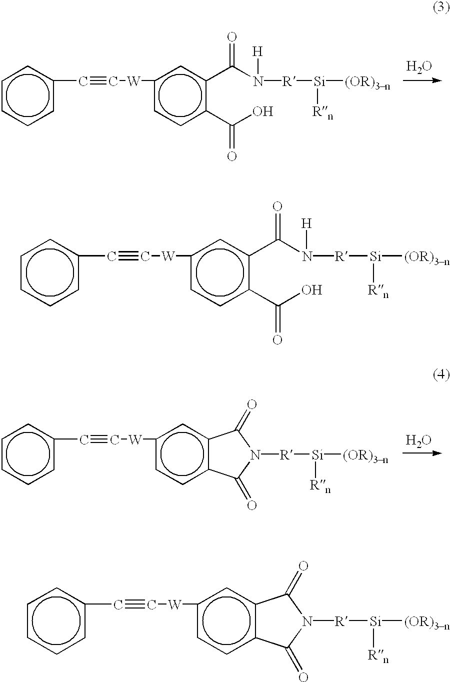

The silanol derivatives of APEIS were applied neat, as a mixture with TEOS, or as a mixture with TEOS and a phenylethynyl containing amide acid (e.g. PETI-5) to the inorganic substrate; which can be any metal, glass, ceramic, etc. that had been surface treated; to provide the appropriate surface in order to improve the adhesion between the inorganic substrate and any phenylethynyl containing adhesive. The surface treatment of the Ti surface (i.e. inorganic substrate) was based upon hydrogen peroxide or sulfuric acid-sodium perborate. Sulfuric acid was employed to produce a fresh surface, while the alkaline perborate acted as an oxidizing agent to afford a new stable oxide layer. Upon the application of heat (˜110° C. for 0.5 hr) the silanol groups of APEIS, neat or as a mixture with TEOS or TEOS/PETI-5, condense to generate oxane and siloxane bonds to the inorganic substrate as depicted in FIG. 1 and previously described. An additional drying step at 220° C. for 0.5 hour was employed to remove NMP. The phenylethynyl group of APEIS reside on the surface of the treated inorganic substrate and upon the application of heat (288 to 371° C.) and pressure reacted with the phenylethynyl groups of the adhesive. The phenylethynyl groups of the adhesive can be either pendent, terminal or in the backbone or any combination thereof.

TABLE 1
Preliminary Titanium-to-Titanium Adhesive Properties¹

| | | | RT, psi | RT (3 day |
|---|---|---|---|---|
| | | | [177° C., psi] | WB²), psi |
| Coupling | | Surface | (Cohesive | (Cohesive |
| Agent System | Ex. | Treatment | failure, %) | failure, %) |
| 15% PETI-5 | 6 | Perborate | 7657 (83) | 4618 (25) |
| 15% PETI-5/TEOS | 7 | GB/Peroxide | 3554 (30) | 1577 (2) |
| 2% APEIS-1³ | 8 | GB⁴/ | 4050 (33) | 3561 (20) |
| | | Peroxide | | |
| 2% APEIS-1/TEOS | 9 | Perborate | 2932 (11) | 1850 (13) |
| 15% APEIS-1/TEOS⁵ | 10 | Perborate | 2142 (0) | 1744 (0) |
| 15% APEIS-1/TEOS | 10 | Perborate | 2164 (0) | 1822 (0) |
| 2.5% PETI-5/APEIS- | 11 | GB/Peroxide | (79) | 2551 (6) |
| 1/TEOS | | | [4679 (78)] | |
| 15% PETI-5/APEIS- | 12 | GB/Peroxide | 6841 (99) | 5783 (95) |
| 1/TEOS | | | | |
| 15% PETI-5/APEIS- | 12 | Perborate | 8074 (50) | 6384 (20) |
| 1/TEOS⁵ | | | | |
| 15% PETI-5/APEIS- | 12 | Perborate | (91) | 6461 (83) |
| 1/TEOS | | | [4734 (93)] | |

¹Lap shear specimens prepared using FMx5 ® and bonded in a hydraulic press at 50 psi for 1 hour at 371° C.
²WB = waterboil
³Aromatic phenylethynyl imide silane
⁴GB = grit blast
⁵Lap shear specimens prepared using FMx5 ® and bonded in an autoclave at 50 psi for 1 hour at 371° C.

Ti (6A1-4V) adherends were surface treated with peroxide or sulfuric acid-sodium perborate prior to the application of the formulations of APEIS-1, APEIS-1/TEOS, PETI-5/TEOS/APEIS-1 or PETI-5/APEIS-1 /TEOS. Lap shear specimens were then fabricated from FM×5® (PETI-5 based supported adhesive film from Cytec-Fiberite, Harve de Grace, Md.) and the treated Ti adherends under 50 psi at 371° C. for 1 hour after a 1 hour hold at 252° C. for 1 hour under vacuum (˜15 psi). The APEIS-1 (Ex. 8), APEIS 1/TEOS (Ex. 9 and 10), and PETI-5/TEOS (Ex. 7) formulations provided low initial adhesive strengths (≦4000 psi) with predominantly adhesive failures (Table 1). Poor retention of adhesive properties and increasing adhesive failures were noted after a 3 day water boil for these formulations. The best results obtained to date were achieved with the formulations of PETI-5/APEIS-1/TEOS (Ex. 12). High initial lap shear strengths ranging from 6850 to 8100 psi with ≧91% cohesive failure at room temperature and 4700 psi at 177° C. were obtained. When PETI-5 (Ex. 6) was used as the coupling agent with no silanol groups present and a perborate surface treatment, comparable RT adhesive properties were obtained. However, after a 3 day water boil the adhesive properties were significantly lower with predominantly adhesive failure. These values were comparable to values obtained from PASA Jell 107 and chromic acid anodized (CAA) surface treated Ti lap shear specimens with a PETI-5 primer (Table 2). After a 3 day water boil, ˜85% of the initial strength (5780 to 6460 psi) remained with predominantly cohesive failure. In comparison, Ti adherends with PASA Jell 107 and CAA surface treatments retained ˜85% of their initial strengths but the failures were predominantly adhesive.

TABLE 2
Effect of Surface Treatment on PETI-5 Properties

| Surface | | | 177° C., | RT after 3 d |
|---|---|---|---|---|
| Treatment | Primer | RT, psi | psi | water boil, psi |
| PASA Jell | PETI-5 | 7100 | 4350 | 5950 |
| 107 ™¹ | | | | |
| CAA²⁻ | BRx5 ™ | 7000 | 5500 | — |
| Perborate³ | 15% PETI-5/ | 6980 | 4735 | 6460 |
| | APEIS-1/TEOS | | | |
| Perborate³ | 15% PPEIDS-1/ | 8800 | — | 8110 |
| | TEOS | | | |

¹Lap shear specimens prepared at 350° C. for 1 hour under 75 psi with PETI-5 adhesive tape.
²Lap shear specimens prepared at 350° C. for 1 under 50 psi with FMx5 ® adhesive tape.
³Lap shear specimens prepared at 371° C. for 1 hour under 50 psi with FMx5 ® adhesive tape.

Pendent Phenylethynyl Imide Disilanes

Controlled molecular weight amide acids of PPEIDS-1 were prepared by the reaction of diamine(s) and diamine(s) containing pendent phenylethynyl group(s) with an excess of dianhydride(s) and endcapped with amine containing substituted silanes. For example, PPEIDS-1 was prepared at a calculated number average molecular weights (\overline{M}ₙ) of 2500 and 5000 g/mol in NMP from 3,3′,4,4′-biphenyltetracarboxylic dianhydride, 3,4′-oxydianiline, and 3,5-diamino-4′-phenylethynylbenzophenone and endcapped with aminophenyltrimethoxysilane as illustrated in Eqn. 5. The inherent viscosities of the amide acid oligomer in NMP at 25° C. were 0.21 and 0.28 dL/g for the 2500 and 5000 g/mol versions, respectively. Conversion of the trimethoxysilyl endgroups to the silanol derivatives was performed by the addition of water to stirred NMP solutions of the amide acids of PPEIDS-1 at room temperature as depicted in Eqn. 6. The silanol endcapped amide acids of PPEIDS-1 were applied neat or as a mixture

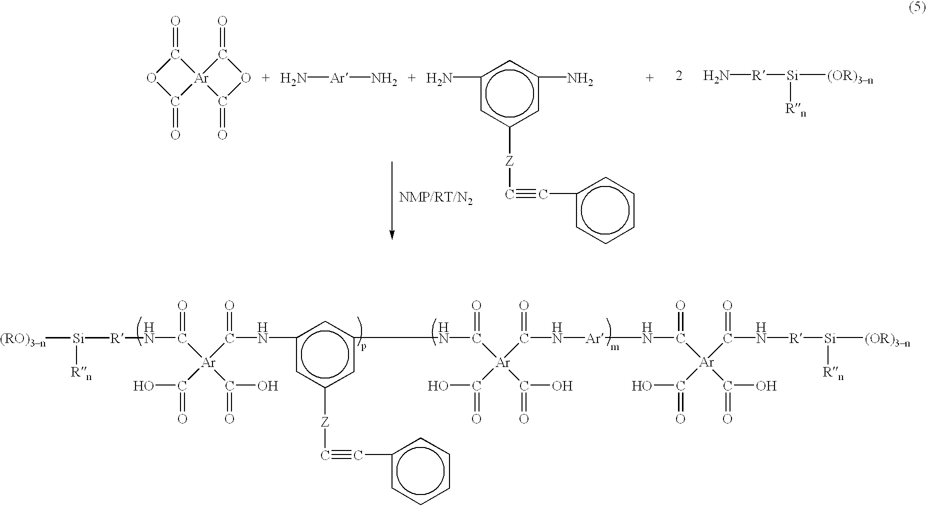

(where p approximately ranges from 1 to 1,000, and m approximately ranges from 1 to 1,000)

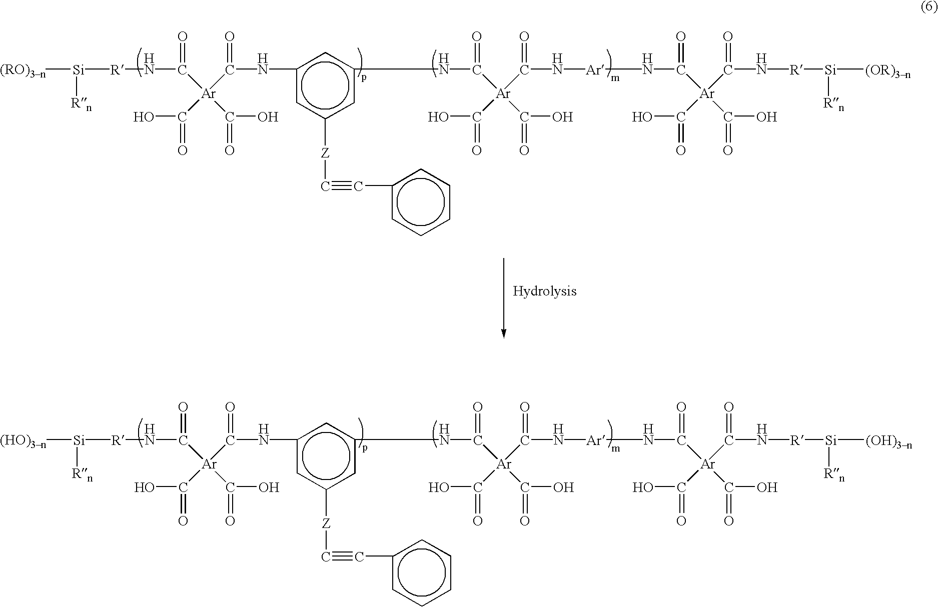

(where p approximately ranges from 1 to 1,000, and m approximately ranges from 1 to 1,000) with TEOS to the inorganic substrate, which can be any metal, glass, ceramic, etc. that had been surface treated to provide the appropriate surface in order to improve the adhesion between the inorganic substrate and any phenylethynyl containing adhesive. The surface treatment of the Ti surface (i.e. inorganic substrate) was based upon hydrogen peroxide or sulfuric acid-sodium perborate as previously described. Upon the application of heat (110° C. for 0.5 hr) the silanol groups of PPEIDS-1, neat or as a mixture with TEOS, condense to generate oxane and siloxane bonds to the inorganic substrate as depicted in FIG. 2 and previously described. An additional drying step at 220° C. for 0.5 hour was employed to remove NMP. The pendent phenylethynyl groups of PPEIDS-1 are distributed randomly on the polymer backbone on the surface of the treated inorganic substrate and upon the application of heat (288 to 371° C.) and pressure reacted with the phenylethynyl groups of the host resin of the adhesive. The phenylethynyl groups of the host resin of the adhesive can be either pendent, terminal, pendent and terminal, or in the backbone or any combination thereof.

Ti adherends were surface treated with peroxide or sulfuric acid-sodium perborate prior to the application of the formulations of PPEIDS-1 or PPEIDS-1/TEOS. Lap shear specimens were then prepared from FM×5® (PETI-5 based supported adhesive film) and the treated Ti alloy adherends under 50 psi at 371° C. for 1 hr. The PPEIDS-1 (\overline{M}ₙ=5000 g/mol) formulation provided an initial strength of 6100 psi with predominately cohesive failure (Table 3). After a 3 day water boil, ˜70% of the original strength was retained with increasing adhesive failure. The best results were obtained for a PPEIDS-1 (\overline{M}ₙ=2500 g/mol)/TEOS formulation (Ex. 18). Lap shear strengths of 8800 psi were obtained with cohesive failures. Upon a 3 day water boil, the failures were cohesive with ˜92% of the initial lap shear strength retained. These values were higher than those obtained for Ti adherends surface treated with PASA Jell or CAA and primed with PETI-5 and tested at room temperature and after a 3 day water boil.

Long-Term Stability at an Elevated Temperature (177° C.)

Lap shear strengths of specimens treated with 15% PETI-5/APEIS/TEOS were measured at RT after aging unstressed specimens at 177° C. in flowing air (Table 4). The specimens exhibited good strength retention even after 2000 hrs aging.

TABLE 3
Preliminary Titanium-to-Titanium Adhesive Properties¹

| | | | RT, psi [177° C., | RT |
|---|---|---|---|---|
| | | | psi] | (3 day WB²), |
| Coupling | | Surface | (Cohesive failure, | psi (Cohesive |
| Agent System | Ex. | Treatment | %) | failure, %) |
| 2% PPEIDS-1 | 13 | None | 4409 (45) | 1352 (2) |
| (\overline{M}ₙ = 5000 | | | | |
| g/mole)³ | | | | |
| 2% PPEIDS-1 | 13 | GB⁴ | 5302 (95) | 1456 (0) |
| (\overline{M}ₙ = 5000 | | | | |
| g/mole) | | | | |
| 2% PPEIDS-1 | 13 | GB/Peroxide | 6073 (88) | 4291 (53) |
| (\overline{M}ₙ = 5000 | | | | |
| g/mole) | | | | |
| 15% PPEIDS-1 | 14 | Perborate | 3300 (0) | 2257 (0) |
| (\overline{M}ₙ = 2500 | | | | |
| g/mole) | | | | |
| 2% PPEIDS-1 | 15 | GB/Peroxide | 5097 (68) | 4147 (41) |
| (\overline{M}ₙ = 2500 | | | [4223 (85)] | |
| g/mole)/TEOS | | | | |
| 8% PPEIDS-1 | 16 | Perborate | 4813 (15) | 2665 (9) |
| (\overline{M}ₙ = 2500 | | | [5286 (56)] | |
| g/mole)/TEOS | | | | |
| 10% PPEIDS-1 | 17 | Perborate | 7379 (68) | 4283 (25) |
| (\overline{M}ₙ = 2500 | | | [5161 (81)] | |
| g/mole)/TEOS | | | | |
| 15% PPEIDS-1v | 18 | Perborate | 8800 (95) | 8108 (91) |
| (\overline{M}ₙ = 2500 | | | | |
| g/mole)/TEOS | | | | |

¹Lap shear specimens prepared using FMx5 ® and bonded in a hydraulic press at 50 psi for 1 hour at 371° C.
²WB = waterboil
³Pendent phenylethynyl imide disilane
⁴GB = grit blast

TABLE 4
Lap shear strengths of PAT after aging at 177° C.

| Time (hr) | 0 hr | 500 hr | 1000 hr | 2000 hr |
|---|---|---|---|---|
| LSS psi | 6162 ± 390 | 6835 ± 362 | 6027 ± 515 | 5893 ± 855 |
| | (50) | (75) | (53) | (55) |

LSS: RT strength ± standard deviation, psi (cohesive failure mode, %)
Surface treatment: perborate

Concentration Effect

FIG. 3 shows the lap shear strengths of PPEIDS/TEOS specimens at two concentrations: 10 and 15%. For 15% PPEIDS/TEOS, RT strength of 8800 psi with 95% cohesive failure and RT strength after a 3-day water-boil of 8110 psi with 91% cohesive failure were obtained. RT strengths of ˜6700 psi and ˜4100 psi after a 3 day water boil were obtained for the 10% concentration. In addition predominantly adhesive failure was observed in the specimens tested after a 3 day water boil. The higher strengths at RT and after exposure to a hot-wet environment obtained for the 15% concentration. This increase is presumably due to the thicker coating (sol-gel) layer, which provides a priming effect. No primer was applied for the adhesive bonding in this portion of the study. A similar trend was observed for the PETI 5/APEIS/TEOS specimens using various concentrations.

Analysis of Chemical Composition of the Phenylethynyl Containing Imide-Silane Interface by EDX and X-Ray Mapping Using SEM

The structure of the hybrid can be postulated by thermodynamics as well as kinetics. Since the metal substrate has a higher surface energy, the higher surface energy phase containing polar functional groups may diffuse near the metal substrate preferentially. If this diffusion occurs prior to substantial condensation reaction, a higher silica-like structure can develop near the metal substrate, since the silanol group has a higher surface energy than a siloxane group. FIG. 4 shows an EDX line map of a cross-section of the 15% PPPEIDS/TEOS on a Ti (6 A1-4 V) substrate. The silicon and carbon concentrations at the interface exhibit a compositional gradient hybrid structure. X-ray maps also reveal a higher silicon concentration near the Ti substrate (FIG. 5). Similar results were observed for 15% PETI-5/APEIS/TEOS.

Application as a Coupling Agent for Sizing Fibers

The phenylethynyl containing imide-silanes (APEIS and PPEIDS) can be used as a coupling agent to size inorganic fibers such as glass, carbon, and alumina fibers. Silane moieties in the imide-silanes and/or TEOS can react with hydroxyl groups on the fiber surface to form oxane bonds. The phenylethynyl groups can diffuse into an organic resin matrix or adhesive at the interface and crosslink with a phenylethynyl containing resin or adhesive to reinforce the interface. Table 5 shows lap shear strengths of Ti lap shear specimens treated with 15% PETI-5/APEIS/TEOS. 2% APEIS and PPEIDS solutions were used to size E-glass scrim cloths and PETI-5 amide acid resin was used to prepare the adhesive tapes using the sized glass fabric. E-glass fabric with an A1100 finish (A 1100 finish is γ-aminopropylsilane) was used as received to prepare adhesive film with PETI-5 amide acid resin for comparison. Both APEIS and PPEIDS sized adhesives exhibited comparable or slightly enhanced lap shear strength with cohesive failure mode without optimization than γ-APS sized adhesive.

TABLE 5
Lap shear strengths of Ti using various sizing agents.

| | | RT, psi |
|---|---|---|
| Sizing agent/resin | Surface treatment | (cohesive failure, %) |
| γ-APS/PETI-5 | Perborate | 5422 ± 443 (N/A) |
| 2% APEIS/PETI-5 | Perborate | 5699 ± 157 (100) |
| 2% PPEIDS/PETI-5 | Perborate | 5953 ± 174 (83) |

15% PETI-5/APEIS/TEOS was used for coupling agent for Ti 6-4.

Application as Protective Coating for Substrates (Corrosion, Wear-Resistance)

In addition to functioning as a coupling agent on an inorganic substrate (e.g. Ti), the phenylethynyl containing imide-silanes can be used as thin-film coatings on inorganic substrates such as glass, stainless steel, aluminum alloy, silicon wafer, copper, etc. Silanol moieties in the imide-silanes and/or inorganic precursor (TEOS) can react with hydroxyl groups on the inorganic substrate to form siloxane bonds and the phenylethynyl groups present in the oligomeric phenylethynyl containing imide silane (PPEIDS) or monomeric phenylethynyl containing imide silane can react to form a film. This thin film can serve as a corrosion, wear resistant membrane. The tensile properties of the thin film can be tailored as a function of inorganic precursor (TEOS) composition and molecular weight and backbone composition of the imide-silanes. The effect of TEOS concentration in the hybrid was evaluated under static tensile and dynamic load conditions. The results are shown in FIGS. 6a-b and 7. The molecular weight of PPEIDS was 2500 g/mol. The static modulus, T_{g} and the dynamic modulus above T_{g} increased, with increasing TEOS concentration; while the yield strength and tan δ decreased. Transparent sol-gel solutions up to 90 wt % TEOS and free-standing transparent films up to 60 wt % TEOS were obtained after curing in flowing air at 371° C. for 1hr. This indicates that the organic (PPEIDS) and inorganic (TEOS) precursors in the hybrid mixed at a molecular level without any observable phase separation within an optical scale.

Thin films of 15% PETI-5/APEIS/TEOS were cast on plate glass, dried in a low-humidity chamber, and subsequently cured in flowing air at 371° C. for 1 hr. Since the cured films covalently bonded with the glass substrate, the film could not be removed even after one-month immersion in a warm water bath. The film though was transparent and suggests that the organic and inorganic precursors in the hybrid mixed at a molecular level. These robust thin film coatings using phenylethynyl containing imide-silanes with organic and inorganic precursors can be applied to any inorganic or organic substrate having hydroxyl groups.

Application as a Matrix Resin for a Composite with Reinforcing Agents (i.e. Fibers)

The phenylethynyl imide-silanes with organic (e.g. PETI-5) and inorganic precursors (e.g. TEOS) can be used as a matrix resin to formulate a composite with unsized reinforcing agents (i.e. fibers) possessing the appropriate functionality. The silane moieties in the resin can create a strong interface between the resin matrix and the reinforcing agent in-situ and provide good compatibility and uniform dispersion. This in-situ sizing and dispersion of inclusions can be performed during processing (compounding, extrusion, injection molding, and resin transfer molding).

Application as a Functionalizing Agent with Clays and Nanotubes

The phenylethynyl imide-silanes (PPEIDS) and imide silanes (APEIS) and/or inorganic precursors (e.g. TEOS) can be used to functionalize clays and nanotubes with phenylethynyl substituents through the reaction of the silanol functionality of the former with hydroxy functionalities present on the clays and nanotubes. The functionalized clays and nanotubes can then be used to react with phenylethynyl containing and non-phenylethynyl containing resins to covalently bind these materials with the resin. The phenylethynyl functionalized clays and nanotubes can likewise be reacted with appropriate groups through the phenylethynyl group to provide other functionalities to the materials.

Application as an Adhesion Promoter for Non-Phenylethynyl Adhesives

The phenylethynyl imide-silanes were designed to create a strong bond between an inorganic substrate (i.e. Ti) and phenylethynyl containing imide resins. However, the phenylethynyl groups can diffuse into a neighboring non-phenylethynyl containing high performance resin and crosslink with one another. This would result in the formation of a semi-interpenetrating network at the interface between the substrate and non-phneylethynyl containing high performance resin.

Based on the art taught herein, it is obvious to one skilled in the art to prepare phenylethynyl containing imide-silane (APEIS) coupling agents from any amine containing an alkoxysilyl group and a phenylethynyl containing anhydride. It is also obvious to one skilled in the art to prepare controlled molecular weight pendent phenylethynyl amide acid oligomers terminated with alkoxy silanes (PPEIDS) from any diamine(s), diamine(s) containing pendent phenylethynyl groups, dianhydride(s), and terminated with any amine containing an alkoxysilyl group. Furthermore, it is obvious to one skilled in the art that APEIS and PPEIDS can be used as coupling agents with any phenylethynyl containing polymer, co-polymer, oligomer, co-oligomer, or monomer such as arylene ethers, imides, amides, or any other class of polymers, to improve adhesion between the inorganic substrate (i.e. glass, metal, ceramic, etc.) and the phenylethynyl containing resin. In addition, these materials are useful as sizing agents on any type of fiber (e.g. organic, inorganic) that has the appropriate surface chemistry to react with the silanol functionality to improve the adhesion between the fiber and a phenylethynyl containing resin. It is also obvious to one skilled in the art that the host polymer, co-polymer, oligomer, co-oligomer, or monomer can possess phenylethynyl groups in a terminal, pendent or backbone configuration or any combination thereof.

It is also obvious to one skilled in the art that phenylethynyl containing silane coupling agents can also be prepared from other non-imide heterocyclic parent compounds such as quinoxaline, 1,2,4-triazole, benzimidazole and also from other non-heterocyclic compounds such as arylene ethers.

It is also obvious to one skilled in the art that phenylethynyl containing silane coupling agents can be used as a protective coating on substrates possessing the appropriate functionality.

It is also obvious to one skilled in the art that phenylethynyl containing silane coupling agents can be used to functionalize reinforcing agents (i.e. fibers), clays, and nanotubes with phenylethynyl groups for incorporation into phenylethynyl containing resins. These phenylethynyl functionalized reinforcing agents, clays, and nanotubes can subsequently be reacted with other appropriate chemistries through the phenylethynyl group to provide additional types of chemical functionalities.

It is also obvious to one skilled in the art that phenylethynyl containing silane coupling agents can be used as a semi-interpenetrating network at the interface between the substrate and non-phneylethynyl containing high performance resin.

Having generally described the invention, a more complete understanding thereof can be obtained by reference to the following examples which are provided herein for purposes of illustration only and do not limit the invention.

### Phenylethynyl Containing Imide-Silane Coupling Agents

### EXAMPLE 1

### Synthesis of N-(4-phenylethynylphthalimido)-3(4)-phenyltrimethoxysilane (APEIS-1)

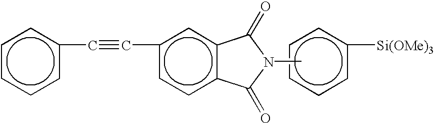

To a flame dried 3 necked 2 L round bottom flask equipped with nitrogen inlet, mechanical stirrer, and Dean-Stark trap were charged 4-phenylethynylphthalic anhydride (115.38 g, 0.4648 mol) and 750 mL of toluene. Prior to use, 4-phenylethynylphthalic anhydride was recrystallized from toluene. Once dissolved, an approximate 85:15 meta:para ratio of aminophenyltrimethoxysilane (99.14 g, 0.4648) was added to the stirred solution. Approximately 1 mL of pyridine was subsequently added and the stirred solution heated at a mild reflux for ˜24 hrs under a nitrogen atmosphere. The solution was subsequently cooled to room temperature and the toluene removed under vacuum to afford a brown solid. The material was dried at 100° C. under vacuum for 1 hour to afford 186.8 g (91%) of a light yellow tan powder. No melting point was observed as determined by differential scanning calorimetry at a heating rate of 10° C./min. By a Fisher Johns melting point apparatus the solid began to melt at 104° C. and formed a clear melt at ˜280° C. The exothermic onset and peak due to the thermal reaction of the phenylethynyl group occurred at 324 and 367° C., respectively, with an enthalpy of 221 J/g. Infrared (KBr, cm⁻¹): 2210 (phenylethynyl); 1778, 1726 (imide); 1100 (Si—O—C).

### EXAMPLE 2

### Synthesis of γ-[N-(4-phenylethynylphthalimido)]propyltriethoxysilane (APEIS-2)

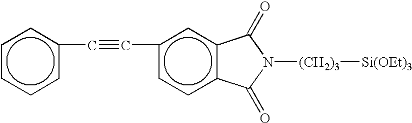

To a flame dried 3 necked 3 L round bottom flask equipped with nitrogen inlet, mechanical stirrer, and Dean-Stark trap was charged 1250 mL of toluene. γ-Aminopropyltriethoxysilane (266.3 g, 1.2029 mol) was then added via a syringe under the toluene surface. Prior to use 4-phenylethynylphthalic anhydride was recrystallized from toluene. 4-Phenylethynylphthalic anhydride (298.6 g, 1.2029 mol) was added to the stirred solution and washed in with an additional 250 mL of toluene. Approximately 4 mL of pyridine was subsequently added to the stirred solution. The stirred solution was heated at a mild reflux for 48 hrs under a nitrogen atmosphere. The solution was subsequently cooled to room temperature and the toluene removed under vacuum to afford 464.1 g (85%) of a viscous brown gum. No melting point was observed as determined by differential scanning calorimetry at a heating rate of 10° C./min. By a Fisher Johns melting point apparatus a broad melt was observed from 65° C. to 115° C. Infrared (KBr, cm⁻¹): 2212 (phenylethynyl); 1770, 1715 (imide); 1089 (Si—O—C). M⁺452 (molecular weight, 452 g/mol.)

### EXAMPLE 3

### Synthesis of N-(4-phenylethynylphthalamide acid)-3(4)-phenyltrimethoxysilane (APEAAS-1)

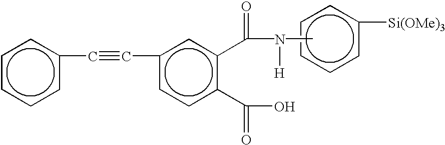

Into a flame dried 250 mL three necked round bottom flask equipped with nitrogen inlet, mechanical stirrer, and drying tube were placed 4-phenylethynylphthalic anhydride (25.6433 g, 0.1033 mol) and 50 mL of N-methyl-2-pyrrolidinone (NMP). Prior to use 4-phenylethynylphthalic anhydride was recrystallized from toluene. The solution was cooled to approximately 10° C. by means of an ice bath. Then aminophenyltrimethoxysilane (22.0349 g, 0.1033 mol) was added and washed in with 20 mL of NMP to afford a 39.74% (w/w) solution. The reaction was allowed to warm to room temperature with stirring and stirred at room temperature for 24 hours under nitrogen.

### Controlled Molecular Weight Pendent Phenylethynyl Amide Acid Oligomers Terminated with Substituted Silanes

### EXAMPLE 4

### (Ratio of 0.85:0.15) 77.29 mole % 3,4′-Oxydianiline and 13.64 mole % 3,5-Diamino-4′-phenylethynylbenzophenone, and 3,3′,4,4′-Biphenyltetracarboxylic Dianhydride, Using 9.07 Mole % Stoichiometric Offset and 18.15 Mole % Aminophenyltrimethoxysilane, (Calculated \overline{M}ₙ=5000 g/Mole) (PPEIDS-1)

The following example illustrates the reaction sequence in Eqn. 3 for the preparation of the controlled molecular weight PPEIDS where Ar′ is equal to a diphenylene where X is an oxygen atom located in the 3,4′-position and Z is equal to a benzoyl group located in the 4-position and Ar is equal to a bis(o-diphenylene) where Y is a nil group located in the 4,4′-position, where R′ is equal to a phenylene group located in the 3 and 4 positions at a ratio of 85:15, where R is equal to a methyl group, and where n is zero. The ratio of diamines [Ar′:R] is 0.85:0.15. The stoichiometric imbalance is 9.07 mole % and the endcapping agent is 18.15 mole % of aminophenyltrimethoxysilane with a meta:para ratio of 85:15.

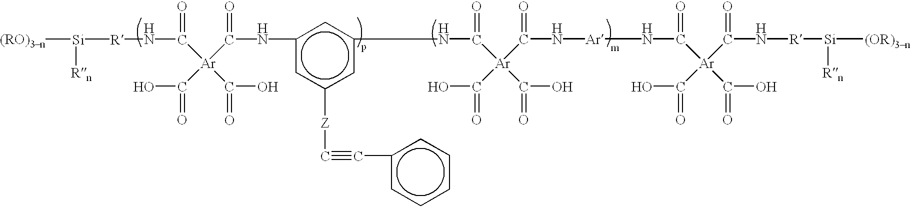

(where p approximately ranges from 1 to 1,000, and m approximately ranges from 1 to 1,000)

Into a flame dried 100 mL three necked round bottom flask equipped with nitrogen inlet, mechanical stirrer, and drying tube were placed 3,4′-oxydianiline (2.5224 g, 0.0126 mol), 3,5-diamino-4′-phenylethynylbenzophenone (0.6944 g, 0.0022 mol), aminophenyltrimethoxysilane (0.6310 g, 0.0030 mol) and 9 mL of N-methyl-2-pyrrolidinone (NMP). After dissolution, the solution was cooled to approximately 10° C. by means of an ice bath. Then a slurry of 3,3′,4,4′-biphenyltetracarboxylic dianhydride (4.7953 g, 0.0163 mol) in 5 mL of NMP was added and washed in with an additional 6 mL of NMP to afford a 29.50% (w/w) solution. The reaction was allowed to warm to room temperature with stirring and stirred at room temperature for 24 hours under nitrogen. The inherent viscosity of the amide acid oligomeric solution (0.5% in NMP at 25° C.) was 0.28 dL/g. A small film cast from NMP and cured in flowing air to 350° C. for 1 hour was flexible and creasable and exhibited a Tg of 313° C. and a Tm of 422° C. by differential scanning calorimetry at a heating rate of 20° C./min.

### EXAMPLE 5

### (Ratio of 0.85:0.15) 70.24 Mole % 3,4′-Oxydianiline and 12.40 Mole % 3,5-Diamino-4′-phenylethynylbenzophenone, and 3,3′,4,4′-Biphenyltetracarboxylic Dianhydride, Using 17.36 Mole % Stoichiometric Offset and 34.72 Mole % Aminophenyltrimethoxysilane, (Calculated \overline{M}ₙ=2500 g/Mole) (PPEIDS-1)

The following example illustrates the reaction sequence in Eqn. 3 for the preparation of the controlled molecular weight PPEIDS where Ar′ is equal to a diphenylene where X is an oxygen atom located in the 3,4′-position and Z is equal to a benzoyl group located in the 4-position and Ar is equal to a bis(o-diphenylene) where Y is a nil group located in the 4,4′-position, where R′ is equal to a phenylene group located in the 3 and 4 positions at a ratio of 85:15, where R is equal to a methyl group, and where n is zero. The ratio of diamines [Ar′:R] is 0.85:0.15. The stoichiometric imbalance is 17.36 mole % and the endcapping agent is 34.72 mole % of aminophenyltrimethoxysilane with a meta:para ratio of 85:15.

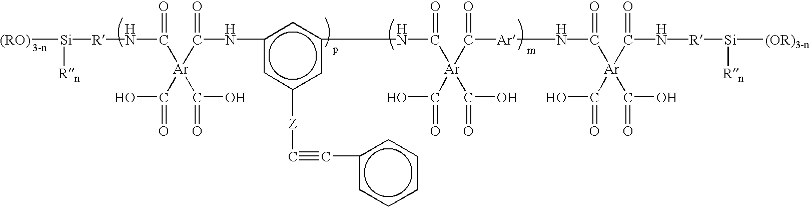

(where p approximately ranges from 1 to 1,000, and m approximately ranges from 1 to 1,000)

Into a flame dried 100 mL three necked round bottom flask equipped with nitrogen inlet, mechanical stirrer, and drying tube were placed 3,4′-oxydianiline (8.7907 g, 0.0439 mol), 3,5-diamino-4′-phenylethynylbenzophenone (2.4209 g, 0.0077 mol), aminophenyltrimethoxysilane (4.6288 g, 0.0217 mol) and 20 mL of N-methyl-2-pyrrolidinone (NMP). After dissolution, the solution was cooled to approximately 10° C. by means of an ice bath. Then a slurry of 3,3′,4,4′-biphenyltetracarboxylic dianhydride (18.3890 g, 0.0625 mol) in 20 mL of NMP was added and washed in with an additional 21 mL of NMP to afford a 35.20% (w/w) solution. The reaction was allowed to warm to room temperature with stirring and stirred at room temperature for 24 hours under nitrogen. The inherent viscosity of the amide acid oligomeric solution (0.5% in NMP at 25° C.) was 0.21 dL/g.

### Sol-Gel Solutions

### EXAMPLE 6

### 15% PETI-5 Solution in N-methyl-2-pyrrolidinone

The following example illustrates the preparation of 15% PETI-5 solution in N-methyl-2-pyrrolidinone for use as a primer on Titanium adherends (6A1-4V).

To a 400 mL beaker equipped with a magnetic stirrer and aluminum foil cover was added anhydrous N-methyl-2-pyrrolidinone (NMP, 114.3 g). PETI-5 amide acid solution (85.7g of 35 w/w % solid solution in NMP) was added and the mixture stirred for 0.5 hour at ambient temperature. Pretreated metal panels were dipped into the solution for 3 min. The panels were dried in an oven at 110 and 220° C. for 0.5 hour each, and then allowed to cool to room temperature in the oven slowly. The dried panels were placed in a plastic bag and stored in a desiccator prior to bonding.

### EXAMPLE 7

### 15% PETI-5/TEOS Solution in N-methyl-2-pyrrolidinone

The following example illustrates the preparation of 15% PETI-5/TEOS solution in N-methyl-2-pyrrolidinone for use as a primer on Titanium adherends (6A1-4V).

To a 400 mL beaker equipped with a magnetic stirrer and aluminum foil cover was added anhydrous N-methyl-2-pyrrolidinone (NMP, 80 g). Tetraethoxysilane (TEOS, 5.5 g) was then added over a 5 min period to the stirred solvent at ambient temperature. PETI-5 amide acid solution (120 g of 25 w/w % solution in NMP) was added and the mixture stirred for 0.5 hour at ambient temperature to afford an approximate 15% PETI-5/TEOS solution in NMP. Distilled water (5.5 g) was added to the stirred solution to hydrolyze the alkoxy silane groups in TEOS. A white precipitate formed immediately, which dissipated after approximately 5 min. The solution was stirred for an additional 1 hour at ambient temperature and vacuum filtered, if necessary. The sol-gel solution was stirred at least 12 hours before applying to pretreated metal substrates. The pretreated metal panels were dipped into the solution for 3 min. The sol-gel treated panels were dried in an oven at 110 and 220° C. for 0.5 hour each, and then allowed to cool slowly to room temperature in the oven. The dried panels were placed in a plastic bag and stored in a desiccator prior to bonding.

### EXAMPLE 8

### 2% APEIS-2 Solution in N-methyl-2-pyrrolidinone

The following example illustrates the preparation of 2% APEIS-2 solution in N-methyl-2-pyrrolidinone for use as a primer on Titanium adherends (6A1-4V).

To a 400 mL beaker equipped with a magnetic stirrer and aluminum foil cover was added anhydrous N-methyl-2-pyrrolidinone (NMP, 196 g). APEIS-2 powder (4 g) was added to the beaker with stirring until dissolved. Distilled water (4 g) was added to the stirred solution to hydrolyze the alkoxy silane groups in APEIS. A white precipitate formed immediately, which dissipated after approximately 5 min. The solution was stirred for 1 hour at ambient temperature. If necessary the solution was filtered using a vacuum aspirator. The filtrate was stirred at least 12 hours before applying to pretreated metal substrates. The pretreated metal panels were dipped into the solution for 3 min at ambient temperature. The sol-gel treated panels were dried in an oven at 110 and 220° C. for 0.5 hour each, and then allowed to cool slowly to room temperature in the oven. The dried panels were placed in a plastic bag and stored in a desiccator prior to bonding.

### EXAMPLE 9

### 2% APEIS-2/TEOS Solution in N-methyl-2-pyrrolidinone

The following example illustrates the preparation of 2% APEIS-2/TEOS solution in N-methyl-2-pyrrolidinone for use as a primer on Titanium adherends (6A1-4V).

To a 400 mL beaker equipped with a magnetic stirrer and aluminum foil cover was added anhydrous N-methyl-2-pyrrolidinone (NMP, 210.7 g). Tetraethoxysilane (TEOS, 5.5 g) was then added over a 5 min period to the stirred solvent at ambient temperature. APEIS-2 powder (4.3 g) was added into the beaker with stirring for 0.5 h. Distilled water (5.5 g, *no extra water for APEIS) was added to the stirred solution to hydrolyze the alkoxy silane groups in TEOS. A white precipitate formed immediately, which dissipated after approximately 5 min. The solution was stirred for an additional 1 hour at ambient temperature and vacuum filtered, if necessary. To prepare the 2% PETI-5-APEIS/TEOS solution, 35.2g of the 15% PETI-5-APEIS/TEOS was placed in a 400 ml beaker and 171.7 g of NMP was added. The diluted (2.5%) sol-gel solution was stirred at least 12 hours before applying to pretreated metal substrates. The pretreated metal panels were dipped into the solution for 3 min. The sol-gel treated panels were dried in an oven at 110 and 220° C. for 0.5 hour each, and then allowed to cool slowly to room temperature in the oven. The dried panels were placed in a plastic bag and stored in a desiccator prior to bonding.

### EXAMPLE 10

### 15% APEIS-2/TEOS Solution in N-methyl-2-pyrrolidinone

The following example illustrates the preparation of 15% APEIS-2/TEOS solution in N-methyl-2-pyrrolidinone for use as a primer on Titanium adherends (6A1-4V).

To a 400 mL beaker equipped with a magnetic stirrer and aluminum foil cover was added anhydrous N-methyl-2-pyrrolidinone (NMP, 194 g). Tetraethoxysilane (TEOS, 5.5 g) was then added over a 5 min period to the stirred solvent at ambient temperature. APEIS-2 powder (4.3 g) was added into the beaker with stirring for 0.5 h. Distilled water (5.5 g, *no extra water for APEIS) was added to the stirred solution to hydrolyze the alkoxy silane groups in TEOS. A white precipitate formed immediately, which dissipated after approximately 5 min. The solution was stirred for an additional 1 hour at ambient temperature and vacuum-filtered, if necessary. The sol-gel solution was stirred at least 12 hours before applying to pretreated metal substrates. The pretreated metal panels were dipped into the solution for 3 min. The sol-gel treated panels were dried in an oven at 110 and 220° C. for 0.5 hour each, and then allowed to cool slowly to room temperature in the oven. The dried panels were placed in a plastic bag and stored in a desiccator prior to bonding.

### EXAMPLE 11

### 2.5% PETI-5-APEIS-2/TEOS Solution in N-methyl-2-pyrrolidinone

The following example illustrates the preparation of 2.5% PETI-5-APEIS-2/TEOS solution in N-methyl-2-pyrrolidinone for use as a primer on Titanium adherends (6A1-4V).

To a 400 mL beaker equipped with a magnetic stirrer and aluminum foil cover was added anhydrous N-methyl-2-pyrrolidinone (NMP, 122.3 g). APEIS-2 powder (4.3 g) was added into the beaker with stirring until dissolved. Tetraethoxysilane (TEOS, 5.5 g) was then added over a 5 min period to the stirred solvent at ambient temperature. PETI-5 amide acid solution (73.4 g of 35 w/w % solid solution in NMP) was added and the mixture stirred for 0.5 hour at ambient temperature to afford an approximate 15% PETI-5 APEIS/TEOS solution in NMP. Distilled water (5.5 g) was added to the stirred solution to hydrolyze the alkoxy silane groups in TEOS. A white precipitate formed immediately, which dissipated after approximately 5 min. The solution was stirred for an additional 1 hour at ambient temperature and vacuum filtered, if necessary. To prepare the 2% PETI-5-APEIS/TEOS solution, 35.2 g of the 15% PETI-5-APEIS/TEOS was placed in a 400 ml beaker and 171.7 g of NMP was added. The diluted (2.5%) sol-gel solution was stirred at least 12 hours before applying to pretreated metal substrates. The pretreated metal panels were dipped into the solution for 3 min. The sol-gel treated panels were dried in an oven at 110 and 220° C. for 0.5 hour each, and then allowed to cool slowly to room temperature in the oven. The dried panels were placed in a plastic bag and stored in a desiccator prior to bonding.

### EXAMPLE 12

### 15% PETI-5-APEIS-2/TEOS Solution in N-methyl-2-pyrrolidinone

The following example illustrates the preparation of 15% PETI-5-APEIS-2/TEOS solution in N-methyl-2-pyrrolidinone for use as a primer on Titanium adherends (6A1-4V).

To a 400 mL beaker equipped with a magnetic stirrer and aluminum foil cover was added anhydrous N-methyl-2-pyrrolidinone (NMP, 122.3 g) and APEIS-2 (4.3 g). The mixture was stirred at ambient temperature until completely dissolved. Tetraethoxysilane (TEOS, 5.5 g) was then added over a 5 min period to the stirred solution at ambient temperature. PETI-5 amide acid solution (73.4 g of 35% solid solution in NMP) was added and the mixture stirred for 0.5 hour at ambient temperature to afford an approximate 15% PETI-5 APEIS-2/TEOS solution in NMP. The ratio of the various reactants were as follows: PETI-5:APEIS-2=6:1 (w/w), PETI-5-APEIS-2:NMP=15:85 (w/w), and PETI-5-APEIS-2:TEOS=85:15 (w/w). Distilled water (5.5 g) was added to the stirred solution to hydrolyze the alkoxy silane groups in APEIS-2 and TEOS. A white precipitate formed immediately, which dissipated after approximately 5 min. The solution was stirred for an additional 1 hour at ambient temperature and vacuum filtered, if necessary. The ratio of the reactants in the sol-gel was PETI-5-APEIS-2:SiO₂=95:5 (w/w). The filtered sol-gel solution was stirred at least 5 hour before applying to pretreated metal substrates. The pretreated metal panels were dipped into the solution for 3 min at ambient temperature. The sol-gel treated panels were dried in an oven at 110 and 220° C. for 0.5 hour at each temperature, and then allowed to slowly cool to room temperature in the oven. The thickness of the sol-gel coating after drying was approximately 1-2 μm as determined by Scanning Electron Microscopy and Auger Electron Spectrometry Depth profile. The dried panels were placed in a plastic bag and stored in a desiccator prior to bonding.

### EXAMPLE 13

### 2% PPEIDS-1 (\overline{M}ₙ=5000 g/Mole) Solution in N-methyl-2-pyrrolidinone

The following example illustrates the preparation of 2% PPEIDS-1 (\overline{M}ₙ=5000 g/mole) solution in N-methyl-2-pyrrolidinone for use as a primer on Titanium adherends (6A1-4V).

To a 400 mL beaker equipped with a magnetic stirrer and aluminum foil cover was added anhydrous N-methyl-2-pyrrolidinone (NMP, 186.44 g). PPEIDS-1 amide acid solution (13.56 g of 35 w/w % solid solution in NMP) was added and the mixture stirred for 0.5 hour at ambient temperature. Distilled water (2.0 g) was added to the stirred solution to hydrolyze the alkoxy silane groups in PPEIDS-1. A white precipitate formed immediately, which dissipated after approximately 5 min. The solution was stirred for an additional 1 hour at ambient temperature and vacuum filtered, if necessary. The sol-gel solution was stirred at least 12 hours before applying to pretreated metal substrates. The pretreated metal panels were dipped into the solution for 3 min. The sol-gel treated panels were dried in an oven at 110 and 220° C. for 0.5 hour each, and then allowed to cool slowly to room temperature in the oven. The dried panels were placed in a plastic bag and stored in a desiccator prior to bonding.

### EXAMPLE 14

### 15% PPEIDS-1 (\overline{M}ₙ=2500 g/Mole) Solution in N-methyl-2-pyrrolidinone

The following example illustrates the preparation of 15% PPEIDS-1 (\overline{M}ₙ=2500 g/mole) solution in N-methyl-2-pyrrolidinone for use as a primer on Titanium adherends (6A1-4V).

To a 400 mL beaker equipped with a magnetic stirrer and aluminum foil cover was added anhydrous N-methyl-2-pyrrolidinone (NMP, 108.4 g). PPEIDS-1 amide acid solution (80.51g of 35.2 w/w % solid solution in NMP) was added and the mixture stirred for 0.5 hour at ambient temperature. Distilled water (2.5 g) was added to the stirred solution to hydrolyze the alkoxy silane groups in PPEIDS-1. A white precipitate formed immediately, which dissipated after approximately 5 min. The solution was stirred for an additional 1 hour at ambient temperature and vacuum filtered, if necessary. The sol-gel solution was stirred at least 12 hours before applying to pretreated metal substrates. The pretreated metal panels were dipped into the solution for 3 min. The sol-gel treated panels were dried in an oven at 110 and 220° C. for 0.5 hour each, and then allowed to cool slowly to room temperature in the oven. The dried panels were placed in a plastic bag and stored in a desiccator prior to bonding.

### EXAMPLE 15

### 2% PPEIDS-1 (\overline{M}ₙ=2500 g/Mole)/TEOS Solution in N-methyl-2-pyrrolidinone

The following example illustrates the preparation of 2% PPEIDS-1 (\overline{M}ₙ=2500 g/mole)/TEOS solution in N-methyl-2-pyrrolidinone for use as a primer on Titanium adherends (6A1-4V).

To a 400 mL beaker equipped with a magnetic stirrer and aluminum foil cover was added anhydrous N-methyl-2-pyrrolidinone (NMP, 186.44g). Tetraethoxysilane (TEOS, 0.7 g) was then added over a 5 min period to the stirred solvent at ambient temperature. PPEIDS-1 amide acid solution (13.56 g of 35 w/w % solid solution in NMP) was added and the mixture stirred for 0.5 hour at ambient temperature to afford an approximate 2% PPEIDS-1/TEOS solution in NMP. Distilled water (0.7 g, *no extra water for PPEIDS-1) was added to the stirred solution to hydrolyze the alkoxy silane groups in TEOS. A white precipitate formed immediately, which dissipated after approximately 5 min. The solution was stirred for an additional 1 hour at ambient temperature and vacuum filtered, if necessary. The sol-gel solution was stirred at least 12 hours before applying to pretreated metal substrates. The pretreated metal panels were dipped into the solution for 3 min. The sol-gel treated panels were dried in an oven at 110 and 220° C. for 0.5 hour each, and then allowed to cool slowly to room temperature in the oven. The dried panels were placed in a plastic bag and stored in a desiccator prior to bonding.

### EXAMPLE 16

### 8% PPEIDS-1 (\overline{M}ₙ=2500 g/Mole)/TEOS Solution in N-methyl-2-pyrrolidinone

The following example illustrates the preparation of 5% PPEIDS-1 (\overline{M}ₙ=2500 g/mole)/TEOS solution in N-methyl-2-pyrrolidinone for use as a primer on Titanium adherends (6A1-4V).

To a 400 mL beaker equipped with a magnetic stirrer and aluminum foil cover was added anhydrous N-methyl-2-pyrrolidinone (NMP, 154.73 g). Tetraethoxysilane (TEOS, 3.6 g) was then added over a 5 min period to the stirred solvent at ambient temperature. PPEIDS-1 amide acid solution (26 g of 35 w/w % solid solution in NMP) was added and the mixture stirred for 0.5 hour at ambient temperature to afford an approximate 5% PPEIDS-1 /TEOS solution in NMP. Distilled water (3.0 g) was added to the stirred solution to hydrolyze the alkoxy silane groups in TEOS. A white precipitate formed immediately, which dissipated after approximately 5 min. The solution was stirred for an additional 1 hour at ambient temperature and vacuum filtered, if necessary. The sol-gel solution was stirred at least 12 hours before applying to pretreated metal substrates. The pretreated metal panels were dipped into the solution for 3 min. The sol-gel treated panels were dried in an oven at 110 and 220° C. for 0.5 hour each, and then allowed to cool slowly to room temperature in the oven. The dried panels were placed in a plastic bag and stored in a desiccator prior to bonding.

### EXAMPLE 17

### 10% PPEIDS-1 (\overline{M}ₙ=2500 g/Mole)/TEOS Solution in N-methyl-2-pyrrolidinone

The following example illustrates the preparation of 10% PPEIDS-1 (\overline{M}ₙ=2500 g/mole)/TEOS solution in N-methyl-2-pyrrolidinone for use as a primer on Titanium adherends (6A1-4V).

To a 400 mL beaker equipped with a magnetic stirrer and aluminum foil cover was added anhydrous N-methyl-2-pyrrolidinone (NMP, 144 g). Tetraethoxysilane (TEOS, 3.6 g) was then added over a 5 min period to the stirred solvent at ambient temperature. PPEIDS-1 amide acid solution (58 g of 35 w/w % solid solution in NMP) was added and the mixture stirred for 0.5 hour at ambient temperature to afford an approximate 5% PPEIDS-1/TEOS solution in NMP. Distilled water (5.4 g) was added to the stirred solution to hydrolyze the alkoxy silane groups in TEOS. A white precipitate formed immediately, which dissipated after approximately 5 min. The solution was stirred for an additional 1 hour at ambient temperature and vacuum filtered, if necessary. The sol-gel solution was stirred at least 12 hours before applying to pretreated metal substrates. The pretreated metal panels were dipped into the solution for 3 min. The sol-gel treated panels were dried in an oven at 110 and 220° C. for 0.5 hour each, and then allowed to cool slowly to room temperature in the oven. The dried panels were placed in a plastic bag and stored in a desiccator prior to bonding.

### EXAMPLE 18

### 15% PPEIDS-1 (\overline{M}ₙ=2500 g/Mole)/TEOS Solution in N-methyl-2-pyrrolidinone

The following example illustrates the preparation of 15% PPEIDS-1 (\overline{M}ₙ=2500 g/mole)/TEOS solution in N-methyl-2-pyrrolidinone for use as a primer on Titanium adherends (6A1-4V).

To a 400 mL beaker equipped with a magnetic stirrer and aluminum foil cover was added anhydrous N-methyl-2-pyrrolidinone (NMP, 122.3 g). Tetraethoxysilane (TEOS, 5.5 g) was added over a 5 min period with stirring at ambient temperature. PPEIDS-1 amide acid solution (73.4 g of 35 w/w % solid solution in NMP) was added and the mixture stirred for 0.5 hour at ambient temperature to afford an approximate 15% PPEIDS-1/TEOS solution in NMP. The ratio of the various reactants were PPEIDS-1:NMP=15:85 (w/w) and PPEIDS-1:TEOS=85:15 (w/w). Distilled water (5.5 g) was added to the stirred solution to hydrolyze the alkoxy silane groups in PPEIDS-1 and TEOS, which produced a white solid precipitate immediately. The white precipitate dissipated after approximately 5 min. The solution was stirred for an additional 1 hour at ambient temperature and vacuum filtered, if necessary. The ratio of the reactants in the sol-gel was PPEIDS-1:SiO₂=95:5 (w/w). The filtered sol-gel solution was stirred at least 5 hour before applying to pretreated metal substrates. The pretreated metal panels were dipped into the solution for 3 min at ambient temperature. The sol-gel treated panels were dried in an oven at 110 and 220° C. for 0.5 hour at each temperature, and then allowed to slowly cool to room temperature in the oven. The thickness of the sol-gel coating after drying was approximately 1-2 μm as determined by Scanning Electron Microscopy. The dried panels were placed in a plastic bag and stored in a desiccator prior to bonding.

In general, the compositions of the invention may be alternatively formulated to comprise, consist of, or consist essentially of any appropriate components herein disclosed, and such compositions of the invention may additionally, or alternatively, be formulated so as to be devoid, or substantially free, of any components, materials, ingredients, adjuvants or species used in prior art compositions or that otherwise are not necessary to the achievement of the function and objectives of the present invention.

What is claimed is:

1. A compound comprising the following chemical structure: 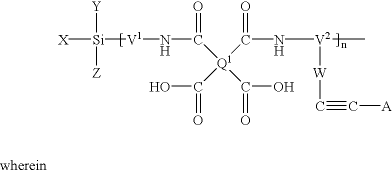
V¹ and V² are alkylene or arylene linking groups;
n approximately ranges from 1 to 1,000;
W is an arylene linking group or a covalent bond;
Q¹ and A are aryl radicals;
X, Y and Z are independently selected from the group consisting of R¹, OR² and OH; and
wherein R¹ and R² are independently alkyl or aryl moieties.

2. The compound of claim 1, wherein the compound is an oligomer.

3. The compound of claim 1, wherein the compound is a polymer.

4. The compound of claim 1, wherein X and Y are each alkoxy groups.

5. The compound of claim 1, wherein X and Y are each hydroxy groups.

6. The compound of claim 1, wherein A is a phenyl radical.

7. The compound of claim 1, wherein A is a naphthyl radical.

8. The compound of claim 1, wherein W is a covalent bond.

9. The compound of claim 1, wherein W is an arylene linking group.

10. The compound of claim 1, wherein W is a benzoyl radical.

11. The compound of claim 1, wherein Q¹ is a benzene radical.

12. The compound of claim 1, wherein Q¹ is a naphthalene radical.

13. The compound of claim 1, wherein R² is a methyl group.

14. The compound of claim 1, wherein R² is an ethyl group.

15. The reaction product of the compound of claim 1 with an oligomer containing a phenylethynyl group.

16. The reaction product of the compound of claim 1 with a monomer containing a phenylethynyl group.

17. The reaction product of the compound of claim 1 with a polymer containing a phenylethynyl group.

18. A method for treating a fibrous substrate, comprising the step of applying to the fibrous substrate the compound of claim 1.

19. In combination with a fibrous substrate, a sizing agent disposed on said substrate, said sizing agent comprising the compound of claim 1.

20. A composite material, comprising the compound of claim 1 and a reinforcing agent.

21. The composite of claim 20, wherein said reinforcing agent comprises a plurality of fibers.

22. A method for functionalizing clay, comprising the steps of:
(a) providing a clay having hydroxy functionalities, and
(b) reacting the clay with the compound of claim 1.

23. The method of claim 22, wherein the clay and the compound of claim 1 are reacted via a condensation reaction.

24. A method for functionalizing nanotubes, comprising the steps of:
(a) providing a plurality of nanotubes having hydroxy functionalities, and
(b) reacting the nanotubes with the compound of claim 1.

25. The method of claim 24, wherein the nanotubes and the compound of claim 1 are reacted via a condensation reaction.

26. A compound comprising the following general chemical structure: 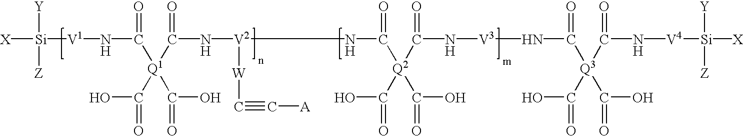
wherein
A is a naphthyl or phenyl group,
n approximately ranges from 1 to 1,000;
m approximately ranges from 1 to 1,000;
W is an arylene linking group or a covalent bond,
Q¹, Q² and Q³ are aryl radicals,
V¹ and V⁴ are alkylene or arylene linking groups,
V² and V³ are arylene linking groups, and
X, Y and Z are independently selected from the group consisting of R¹, OH and OR², where
R¹ and R² are independently alkyl or aryl moieties.

27. The compound of claim 26, wherein W is a covalent bond and A is a phenyl group.

28. The compound of claim 26, wherein V⁴ is an alkylene linkage containing 1 to 8 carbon atoms.

29. The compound of claim 26, wherein V⁴ is a methylene group.

30. The compound of claim 26, wherein V⁴ is a ethylene group.

31. The compound of claim 26, wherein V⁴ is a propylene group.

32. The compound of claim 26, wherein X, Y and Z are hydroxyl groups.

33. The compound of claim 26, wherein X, Y and Z are alkoxy groups.

34. The compound of claim 26, wherein X, Y and Z are methoxy groups

35. A method for treating an inorganic substrate, comprising the step of applying a compound to the substrate to form a treated substrate, said compound comprising the following chemical formula: 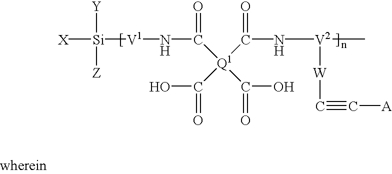
V¹ and V² are alkylene or arylene linking groups;
n approximately ranges from 1 to 1,000;
W is an arylene linking group or a covalent bond;
Q¹ and A are aryl radicals;
X, Y and Z are independently selected from the group consisting of R¹, OR² and OH, and
where R¹ and R² are independently alkyl or aryl moieties.

36. The method of claim 35, wherein the inorganic substrate comprises titanium.

37. The method of claim 35, wherein the compound is applied as a mixture with a phenylethynyl containing amide acid.

38. The method of claim 35, further comprising the step of heating the treated substrate.

39. The method of claim 35, wherein the compound is applied as a mixture with a tetraalkoxysilane.

40. The method of claim 39, further comprising the step of heating the treated substrate.

41. The method of claim 39, wherein the tetraalkoxysilane is tetraethoxysilane.

42. The method of claim 39, wherein the mixture further comprises a phenylethynyl containing amide acid.

43. The method of claim 35, further comprising the step of applying to the treated substrate a second compound containing a phenylethynyl moiety.

44. The method of claim 43, wherein the second compound is an adhesive.

45. The method of claim 43, wherein the second compound is an oligomer.

46. The method of claim 43, wherein the second compound is a polymer.

47. The method of claim 43, wherein the second compound is a copolymer.

48. A compound comprising the following general structure: 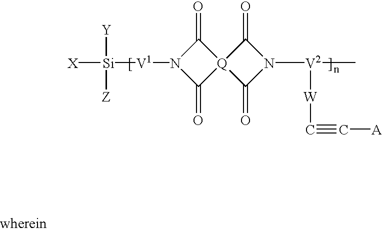
A is an aryl group,
n approximately ranges from 1 to 1,000;
Q is an arylene radical,
V¹ and V² are independently alkylene or arylene linking groups;
W is an arylene linking group or a covalent bond; and
X, Y and Z are independently selected from the group consisting of R¹, OH and OR², wherein
R¹ and R² are independently alkyl or aryl groups.

49. The compound of claim 48, wherein A is a phenyl group.

50. The compound of claim 48, wherein A is a naphthyl group.

51. The compound of claim 48, wherein W is a covalent bond.

52. The compound of claim 48, wherein W is an arylene linking group.

53. The compound of claim 48, wherein Q is a benzene radical.

54. The compound of claim 48, wherein Q is a naphthalene radical.

55. The compound of claim 48, wherein V¹ is an alkylene linkage containing 1 to 8 carbon atoms.

56. The compound of claim 48, wherein V¹ is a methylene group.

57. The compound of claim 48, wherein V¹ is a ethylene group.

58. The compound of claim 48, wherein V¹ is a propylene group.

59. The compound of claim 48, wherein X and Y are hydroxyl groups.

60. The compound of claim 48, wherein R¹ is a methyl group.

61. The compound of claim 48, wherein R¹ is an ethyl group.

62. The reaction product of the compound of claim 48 with an oligomer containing a phenylethynyl group.

63. The reaction product of the compound of claim 48 with a monomer containing a phenylethynyl group.

64. The reaction product of the compound of claim 48 with a polymer containing a phenylethynyl group.

65. In combination with a fibrous substrate, a sizing agent disposed on said substrate, said sizing agent comprising the compound of claim 48.

66. A method for treating a fibrous substrate, comprising the step of applying to the fibrous substrate the compound of claim 48.

67. A composite material, comprising (a) the compound of claim 48, and (b) a reinforcing agent.

68. The composite material of claim 67, wherein said reinforcing agent comprises a plurality of fibers.

69. A method for functionalizing clay, comprising the steps of:
(a) providing a clay having hydroxy functionalities, and
(b) reacting the clay with the compound of claim 48.

70. The method of claim 69, wherein the clay and the compound of claim 48 are reacted via a condensation reaction.

71. A method for functionalizing nanotubes, comprising the steps of:
(a) providing a plurality of nanotubes having hydroxy functionalities, and
(b) reacting the nanotubes with the material of claim 48.

72. The method of claim 71, wherein the nanotubes and the material of claim 48 are reacted via a condensation reaction.

73. A method for treating an inorganic substrate, comprising the step of applying a compound to a substrate, thereby forming a treated substrate, said compound comprising the following general formula: 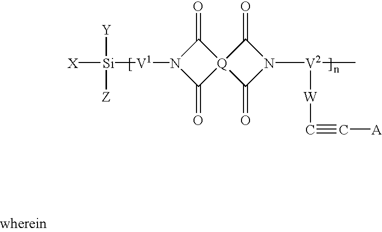
A is an aryl group,
n approximately ranges from 1 to 1,000;
Q is an arylene radical,
V¹ and V² are independently alkylene or arylene linking groups;
W is an arylene linking group or a covalent bond; and
X, Y and Z are independently selected from the group consisting of R¹, OH and OR², wherein
R¹ and R² are independently alkyl or aryl groups.

74. The method of claim 73, wherein the compound is applied as a mixture with a phenylethynyl containing amide acid.

75. The method of claim 73, further comprising the step of heating the treated substrate.

76. The method of claim 73, wherein the compound is applied as a mixture with a tetraalkoxysilane.

77. The method of claim 76, wherein the tetraalkoxysilane is tetraethoxysilane.

78. The method of claim 73, further comprising the step of applying to the treated substrate a second compound containing a phenylethynyl moiety.

79. The method of claim 78, wherein the second compound is an adhesive.

80. The method of claim 78, wherein the second compound is an oligomer.

81. The method of claim 78, wherein the second compound is a polymer.

82. The method of claim 78, wherein the second compound is a copolymer.

83. The method of claim 78, wherein the inorganic substrate comprises titanium.

84. A method for forming imide silanes containing at least one phenylethynyl moiety, comprising the steps of:
(a) providing an anhydride containing at least one phenylethynyl moiety;
(b) providing a substituted silane containing a primary amine group;
(c) reacting the anhydride with the silane, thereby generating an imide and water; and
(d) removing the water essentially simultaneously with the formation of the imide.

85. The method of claim 84, wherein the water is removed by reacting the anhydride and the silane in a solvent medium capable of forming an azeotrope with water.

86. The method of claim 84, wherein the solvent medium comprises toluene.

87. The method of claim 84, wherein the anhydride and the silane are reacted via a condensation reaction.
